(19) United States
(12) Patent Application Publication
(10) Pub. No.: US 2003/0037874 A1
(43) Pub. Date: Feb. 27, 2003

(54) Semiconductor substrate bonding by mass transport growth fusion

(75) Inventors: Zong-Long Liau, Belmont, MA (US); Christine A. Wang, Bedford, MA (US)

Correspondence Address: Theresa A. Lober, T. A. Lober Patent Services, 45 Walden Street, Concord, MA, 01742, US

(73) Assignee: Massachusetts Institute of Technology, Cambridge, MA

(21) Appl. No.: 10/205,704

(22) Filed: Jul. 26, 2002

Related U.S. Application Data
(60) Provisional application No. 60/308,041, filed on Jul. 26, 2001.

(51) Int. Cl. C09J 1/00; B32B 31/00; C09J 5/00

(52) U.S. Cl. 156/306.3; 156/281

(57) ABSTRACT

In bonding a first crystalline semiconductor substrate to a second crystalline semiconductor substrate, a liquid is applied to a first surface of the first substrate and to a first surface of the second substrate to wet both substrate first surfaces. The first surface of the first substrate is brought together with the first surface of the second substrate while the liquid substantially remains on both first surfaces, and then the liquid is evaporated from the substrate first surfaces, while the substrate first faces are together, at an evaporation temperature that is below the boiling point of the liquid at ambient pressure. The substrates are then heat treated at a temperature above the evaporation temperature. Surface channels can be formed in a first surface of at least one of the first and second substrates, and during the heat treatment, a crystal growth promotion vapor can be supplied to the substrates.

This application claims the benefit of U.S. Provisional Application No. 60/308,041, filed Jul. 26, 2001, the entirety of which is hereby incorporated by reference.

### STATEMENT REGARDING FEDERALLY SPONSORED RESEARCH

This invention was made with Government support under Contract No. F19628-95-C-002 awarded by the United States Air Force. The Government has certain rights in the invention.

### BACKGROUND OF THE INVENTION

This invention relates to bonding of semiconductor substrates, such as semiconductor wafers, and more particularly relates to fusion bonding of semiconductor substrates.

Fusion bonding of semiconductor substrates has become an important fabrication technique for enabling manufacture of a wide range of electronic, optoelectronic, and microelectromechanical devices and systems. In such a fusion bonding technique, two or more substrates are brought together and held at an elevated temperature to fuse the substrates together at the interface of the two substrates. For many applications it is desirable that this substrate interface fusion result in monolithic integration of the substrates, that is, that the substrate fusion form covalent bonds across the substrate interface.

One particularly important application of fusion bonding is the monolithic integration of heterogeneous materials, to enable integration of dissimilar semiconductor materials, devices, and systems. Fusion bonding is specifically attractive as a technique for overcoming the well-known limitations of heteroepitaxial processes for producing layers of heterogeneous materials. Heteroepitaxial processes typically involve the epitaxial growth of a semiconductor layer on a dissimilar semiconductor substrate. Quite commonly, the semiconductor substrate material is characterized by a lattice parameter, crystal orientation, and/or other characteristics that are different than that of the semiconductor layer being epitaxially grown. As a result, the density of threading dislocations originated at the heteroepitaxial interface and propagated through the epitaxial layer can be so large as to significantly degrade the performance of devices fabricated in the epitaxial layer. Substrate fusion bonding can under selected processing conditions produce only a matrix of misfit dislocations right at the bond interface, leaving the rest of the material defect-free. It can therefore integrate the dissimilar materials in an essentially defect-free manner, in stark contrast to heteroepitaxy.

Fusion bonding is also important for enabling the monolithic integration of two or more semiconductor layers that have been heteroepitaxially grown. This can be important for applications in which heteroepitaxy is required for forming material layers that could not be otherwise produced, to enable monolithic integration of such layers in formation of devices or systems. For example, for many optoelectronic applications, it can be preferred to fusion bond several heteroepitaxially grown layers to produce a stack of heterogeneous materials that together operate as, e.g., a laser or light emitting diode (LED).

Although fusion bonding of heteroepitaxially grown layers and heteroepitaxial substrate fusion bonding are both well-known and widely employed, several process limitations persist. Most severe of these limitations may be the typically nonuniform and sub-optimal surface qualities of the layers and/or substrates to be bonded. For example, heteroepitaxially grown layers often are characterized by some degree of surface roughness, by an uneven surface plane, and by surface defect structures. But conventional fusion bonding techniques generally require that two layers or substrates to be bonded together be brought into and held in very close proximity during a bonding heat treatment step. As a result, the surface structure of heteroepitaxial materials often can produce only suboptimal proximity conditions, and correspondingly sub-optimal bonding results.

In an effort to overcome this limitation, fusion bonding processes often include a requirement of pressure application to the substrates and/or layers to be fused. Such pressure application is employed to achieve close proximity contact between the surfaces to be bonded in spite of surface defects, surface roughness, and substrate bowing or warpage. Typically pressure is applied to two layers being bonded when the layers are brought together as well as during a heat treatment step.

Although pressure application has been demonstrated to be an effective technique for enhancing the quality of fusion bonding process results, it has been shown to itself introduce unwanted defects in bonded materials. In particular, it has been found that applied pressure can damage the material layers, producing defects throughout the material layers and resulting in sub-optimal device performance. Such defect generation is often the result of plastic deformation of the substrates and/or layers to conform to each other under the applied pressure at elevated bonding temperatures.

Optoelectronic devices, which typically consist of heterogeneous III-V semiconductor material structures, are well-known to be very sensitive to material defects; such defects can act as electronic, non-radiative recombination centers. As a result, the material defects produced by fusion bonding pressure application are typically unacceptable for commercial optoelectronic device applications. But without such pressure application, it has been conventionally understood that true heterogeneous monolithic integration may not be complete without other complicated procedures, due to the sub-optimal characteristics of many heteroepitaxial layers as well as III-V semiconductor substrates. As a result, sub-optimal bonded material quality has been accommodated, or complicated fusion bonding processes have been required, in the production of many fusion bonded devices.

### SUMMARY OF THE INVENTION

The invention overcomes limitations of conventional fusion bonding techniques to enable an uncomplicated, repeatable, and reliable process for substrate growth fusion bonding that produces monolithic integration of the bonded materials. This process provides a method for bonding a first crystalline semiconductor substrate to a second crystalline semiconductor substrate. In the method, there is applied to a first surface of the first substrate and to a first surface of the second substrate a liquid that wets both substrate first surfaces. With this liquid applied, the first surface of the first substrate is brought together with the first surface of the second substrate while the liquid substantially remains on both first surfaces.

While the substrate first faces are together, the liquid is evaporated from the substrate first surfaces at an evaporation temperature that is below the boiling point of the liquid at ambient pressure. Then the substrates are heat treated at a temperature that is above the evaporation temperature. As explained in detail below, this process enables effective and reliable growth fusion between the substrates to monolithically integrate the substrates.

In accordance with the invention, this monolithic substrate integration can also be produced in a second technique for bonding a first crystalline semiconductor substrate to a second crystalline semiconductor substrate. Here surface channels are formed in a first surface of at least one of the first and second substrates. Then the first surface of the first substrate is brought together with the first surface of the second substrate. With the two substrates brought together, the substrate couple is then heat treated while a crystal growth promotion vapor is supplied to the substrates.

If desired, application of a liquid to first surfaces of the first and second substrates can be carried out, in the manner described above, before the first surface of the first substrate is brought together with the first surface of the second substrate. While the substrate first faces are together, and before the heat treatment, the liquid can be evaporated from the substrate first surfaces at an evaporation temperature that is below the boiling point of the liquid at ambient pressure.

These growth fusion bonding processes provided by the invention enable production of a wide range of semiconductor devices and systems. The processes are particularly advantageous for the production of heterostructures, e.g., III-V semiconductor structures, that are employed in electronic and optoelectronic devices and systems. The uncomplicated manner of the processes of the invention, together with the superior monolithic integration result they provide, enable large scale fabrication processes for manufacturing devices and systems.

### BRIEF DESCRIPTION OF THE DRAWINGS

FIG. 1 is a schematic side view of a substrate couple including two substrates to be growth fusion bonded in accordance with the invention and an intermediate capillary liquid that is evaporating from between the substrates;

FIGS. 2A-2C are schematic side views of a substrate couple including two substrates to be growth fusion bonded in accordance with the invention, showing the result of a progression of mass transport and surface energy minimization during the growth fusion bonding process;

FIG. 3 is a schematic view of a process tube provided in accordance with the invention for heat treating a substrate couple to be growth fusion bonded in accordance with the invention, including in the tube sources of vapor for promoting crystal growth between the substrate couple; and

FIG. 4 is a schematic side view of a substrate couple including two substrates to be growth fusion bonded in accordance with the invention, one of the substrates including vapor transport surface channels for promoting growth fusion bonding of the substrates.

### DETAILED DESCRIPTION OF THE INVENTION

When two crystals are brought into contact, they tend to grow together, i.e., coalesce, in order to become more thermodynamically stable. This is a basic material phenomenon, and has been widely known to occur in many metallurgical processes, such as powder sintering and thin film growth. It is recognized in accordance with the invention that a similar process can be caused to occur between semiconductor substrates, such as wafers, and between semiconductor layers and substrates, in a growth fusion bonding process that does not require the application of pressure, even when two or more heterogeneous substrates or layers are employed.

Specifically, the invention provides non-pressure processes for enabling atomic-scale spacing and the production of atomic-scale van derWaals forces between substrates and/or layers to enable very efficient covalent bonding of substrates and/or substrate layers. It is recognized in accordance with the invention that for many applications, to enable very strong bonding between two substrates or layers, the average distance between the surfaces to be bonded is critical—and preferably is in the atomic-scale regime. As explained below, the growth fusion bonding techniques of the invention are particularly advantageous for enabling such, even between dissimilar materials, e.g., heterogeneous materials that are lattice-mismatched and that exhibit surface defects, without generating defects in the materials that are commonly associated with the application of pressure.

The invention further provides pressureless growth fusion bonding techniques for accommodating substrates and layers that cannot as a practical matter be brought into atomic-scale proximity. As explained in detail below, these techniques enable monolithic integration of even heterogeneous materials that do not exhibit optimal surface morphology for achieving initial atomic-scale proximity.

For those materials and substrates for which atomic-scale proximity is to be achieved, in accordance with the invention, surface tension of a liquid medium is employed to pull substrate couples, or stacks of substrates, with or without surface layers on the substrates, together into substantially uniform atomic contact, even where a substrate surface is not atomically flat and includes surface defects. To begin the fabrication sequence, substrates of interest are provided, preferably with their front faces polished. Semiconductor wafers or other substrates can be employed. The invention does not require the use of commercial substrate wafers; pieces of wafers, irregular mechanical platforms, or other substrate configurations can be employed. Electrical and/or mechanical devices and features can be provided on one or both of the substrates. Complementary mechanical features and/or structures can be provided on the substrates for enabling alignment and atomic-scale gap spacing between the features and the substrates. Whatever the substrate configuration employed, one or more layers of material can be provided on the substrate front faces; e.g., an epitaxially-grown layer or layers, and/or heteroepitaxially-grown layer or layers, can be provided on one or both substrates.

Where commercial semiconductor substrate wafers are employed, it can be preferred for many applications to employ semiconductor wafers that are cut off-axis, i.e., off of the crystallographic axis of the semiconductor. It is understood in accordance with the invention that for wafers cut exactly on-axis it can be more difficult to promote atomic dissociation and mobility that aid in the growth fusion bonding process. Off-axis wafers are characterized by a lower atomic dissociation and mobility energy, and therefore are understood to exhibit a stronger tendency toward growth fusion bonding.

It can further be preferred in accordance with the invention to thin at least one of the two substrates to be bonded. Such can enable the thinned substrate to more easily deform in response to liquid surface tension to produce a minimized gap between the substrates. It is to be recognized that such thinning preferably maintains the mechanical integrity of the thinned substrate such that handling of the substrate is practical.

In a first process step, the substrates are cleaned, e.g., by ultrasonic cleaning and a standard semiconductor manufacturing cleaning process, such as an RCA clean, such that the substrates are free of dirt particles, and native oxides are then removed. A standard microfabrication cleaning process can be preferred for many applications, preferably including a native oxide etch step.

Once the substrates are cleaned, they are then rinsed in a liquid that meets two criteria: first, the liquid must wet both of the two surfaces to be bonded together; and second, the liquid must be volatile under selected temperature and pressure conditions, i.e., the liquid must readily evaporate. By “wetting” of the two surfaces is here meant that the adhesive force between the liquid and the substrate surface is greater than the adhesive force within the liquid itself. For many applications, the liquid, here termed the capillary attractive liquid, is preferably provided as methanol, isopropanol, water, or other selected liquid that meets the two requirements given above. Because the liquid must wet both of the bonding surfaces as well as be evaporative, it is preferably selected based on the specific substrate materials to be employed.

The two substrates are rinsed in the selected capillary attractive liquid, and then are assembled wet. This assembly can be carried out in the rinse bath itself or out of the rinse bath; all that is required is that the substrate surfaces to be bonded are wetted by the capillary attractive liquid and are wet at the time of assembly. The assembly of a substrate couple while surfaces of the substrates are wet is carried out in accordance with the invention to enable atomic-scale spacing between the substrates, in the manner described below. In addition, it is found that wet assembly of the substrates maintains the cleanliness of the substrates, free from dust or other particles. Further, the wet assembly prevents the substrate surfaces from exposure to ambient air, thereby reducing or inhibiting oxidation and/or contamination.

For many applications, it can be preferred to assemble together the substrates outside of the liquid bath for ease of orientation and alignment between the substrates. In one example process, a first of the substrates is removed from the liquid bath and positioned on a pedestal with its front face upward. The second substrate is then removed from the bath and aligned face down on the first substrate. It is preferable to complete the face-to-face coupling of the substrates before the liquid evaporates even minimally from either substrate.

For many applications, alignment of a substrate couple outside of the rinse bath can be made quite convenient by precutting the substrates to the same or a similar size and shape, whereby the liquid surface tension developed between the substrates can tend to pull the substrates together in geometric alignment. In addition, use of a tilted pedestal can be found preferable, in conjunction with a mechanical stop, to enable the gravitational force to pull the substrates into geometric alignment. The invention does not require the use of a tilted pedestal for substrate alignment; it is recognized that a variety of mechanical fixtures can be employed to guide the substrates into alignment. It is further recognized that conventional alignment techniques, including e.g., the use of lithographic registration patterns and associated equipment, can be employed to align the substrates.

The substrates are then maintained at a selected temperature and pressure until the capillary attractive liquid has substantially completely evaporated from between the two substrate faces. For applications in which one of the substrates is optically transparent, this evaporation process can be conveniently monitored over time as a function of the interference fringes produced by the thin film of liquid as it evaporates. The fringes are found to gradually move to the edges of the substrates and then to disappear. A fringeless condition indicates a separation between the substrates of less than about one quarter of the visible wavelength, or approximately 1000 Å. If neither of the substrates are optically transparent, then an alternative imaging technique, e.g., an infrared microscopy or imaging system, can be employed to monitor fringes produced during the evaporation process, e.g., where at least one of the substrates is transparent to infrared wavelengths.

At this point, an additional evaporation period is then required for the remaining 1000 Å-thick liquid layer to be removed. In accordance with the invention, it is preferred to quantitatively measure the substrate gap over time to determine the precise evaporation conditions and duration required for completely removing the liquid layer. If desired, a final evaporation step of a very low temperature bake can be undertaken to drive the final remaining liquid out from between the substrates.

In accordance with the invention, mechanical pressing can be employed during the evaporation process for enhancing the process. It is to be noted that such mechanical pressing is not the application of any significant pressure on either of the substrates. In one example configuration, a steel ball can be pressed onto a brass block supported on an intermediate block of copper or rubber, under which the stack of wafers is supplied. This configuration is not required by the invention, and preferably does not produce pressure on the substrates. Whatever configuration is employed, it is found that light pressing of the substrates can aid in accelerating the evaporation of liquid from between the substrates by reducing the size of the gap between the two substrates, but pressure application is to be avoided. The reduced gap resulting from the pressing is found to increase the force of the capillary effect in pulling the substrates together.

During the evaporation process, the temperature of the substrates can be maintained at room temperature, or the temperature of the substrates can be raised above room temperature. Preferably the evaporation temperature is maintained below the boiling point of the capillary attractive liquid, at the ambient pressure of the evaporation, to avoid boiling and possible bursting of the liquid from between the substrates, possibly causing mechanical damage. For many applications, room temperature evaporation can be preferred for simplicity and to minimize thermal stress between the substrates. It is recognized that depending on the size of substrates employed, room temperature evaporation can require a duration of more than 24 hours. If a higher evaporation temperature is to be employed, such is preferably imposed by, e.g., providing the substrates in a furnace tube and slowly ramping the temperature from room temperature to a selected temperature once the substrates are provided in the tube.

The substrates can be maintained under conventional clean room conditions during the evaporation process or can be maintained in an inert gas, e.g., Ar, or a reducing gas, such as H₂, to avoid oxidation and/or contamination. Note, however, that during the evaporation process, the attractive capillary fluid substantially inhibits contaminants from entering the gap between the substrates. After evaporation, the very close spacing between the substrates also disallows in-diffusion of oxygen and/or contaminants, due primarily to the small diffusion channel provided the gap. High-pressure gas can also be employed to pressurize the evaporation environment, e.g., to about 10 atm, to enhance the bonding process. This conditioning of the evaporation environment can be provided in a furnace tube maintained at room temperature or at a selected higher temperature.

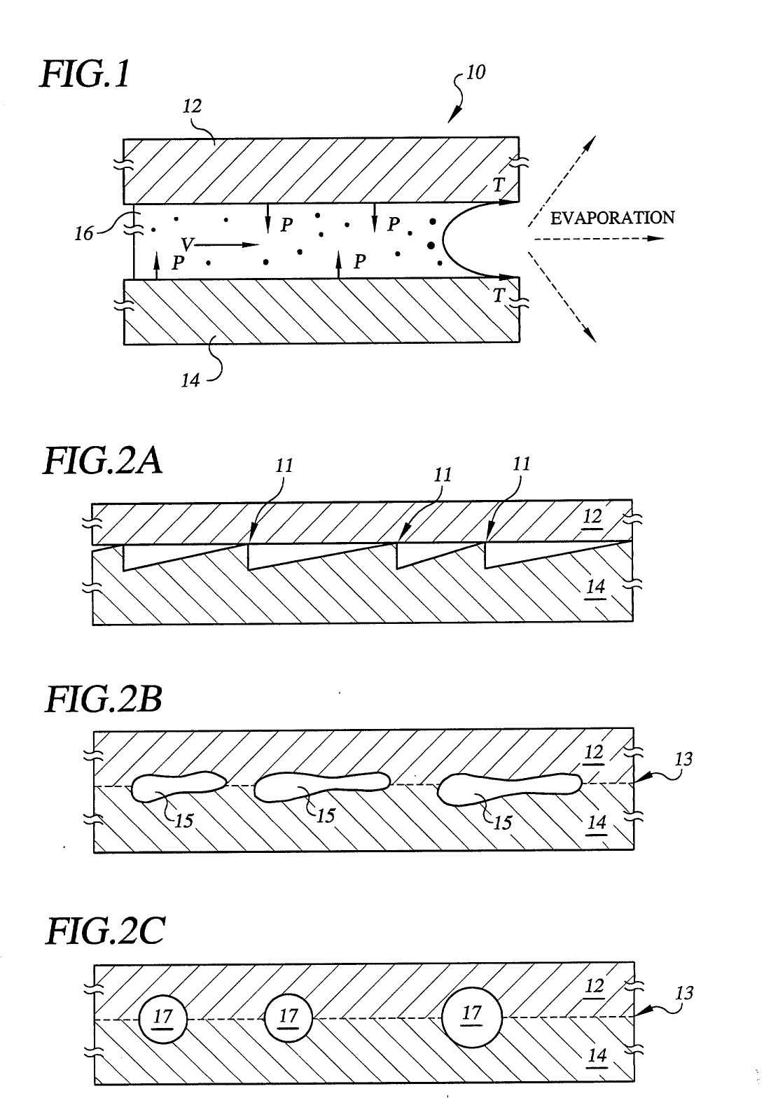

It is found in accordance with the invention that the evaporation process acts to pull the substrate faces into atomic-scale contact. FIG. 1 schematically illustrates this mechanism as provided by the configuration 10 of the invention in which a first substrate 12 has been brought together with a second substrate 14, with a capillary fluid 16 provided between the assembled substrate couple. As evaporation of the fluid occurs at edges of the substrate couple, the surface tension, T, of the fluid drives a flow velocity, V, of the fluid out from between the substrates, producing a pressure, P, on the substrates to move more closely together. As the evaporation process continues, this pressure continues, causing the substrates to continually close the gap between them.

The resulting atomic-scale contact between the substrates cannot be determined by optical interferometry at this level, but can be determined by a process provided by the invention that employs evanescent-wave tunneling of visible or infrared light, for making a quantitative substrate gap measurement. In this process, a focused laser beam is directed at a glancing-angle incidence to the interface of the two substrates. The small atomic-scale gap between the substrates results in partial transmittal, rather than total reflection, of the beam. By measuring the intensity ratio of the transmitted and reflected beams, the average gap between the two substrates can be determined. Using this technique it has been found that substantially complete liquid evaporation can result in a substrate gap of about 15 Å, with points of complete contact between the substrates occurring at various locations across the substrates.

It is recognized that for substrate surfaces that are not optimally flat, i.e., that exhibit some surface waviness, there can exist at the completion of the capillary fluid evaporation process isolated substrate surface regions of air pockets that are surrounded by atomic-scale surface contact. Such isolated air pockets are in effect sealed at their edges by the surrounding contacted surfaces.

In accordance with the invention, substrate air pockets can be reduced by a number of techniques. In one example technique, after capillary evaporation, the substrate stack is submerged in a hydrostatically pressurized chamber. Due to the atomic-scale contact between the substrate surfaces at their edges, the fluid of the chamber cannot diffuse between the substrates. As a result, any isolated air pockets between the substrates yield to the hydrostatic pressure, i.e., are compressed. Unlike conventional mechanical pressure application, this hydrostatic pressure application, of a few atmospheres, represents relatively no substantial pressure, in accordance with the preference of the invention that no pressure be applied to the substrates. Accordingly, the hydrostatic pressure does not damage the substrate material or result in defects in the material in the manner that can be expected for conventional mechanical pressure application.

In a further example technique, after the capillary evaporation step the substrate stack is loaded into a process furnace and the entire furnace tube is pressurized, e.g., by utilizing the high pressure from a regulated Ar tank. This gaseous pressure application, like the liquid hydrostatic pressure application just described, also enables compression of any isolated air pockets existing between the substrate surfaces, and does so without the application of any substantial pressure to the substrates.

It was explained above that prior to bringing two substrates together for bonding, one or both of the substrates can be thinned to a desired thickness. A thinned substrate can be desirable for a variety of applications in the fabrication of electronic, optoelectronic, and microelectromechanical devices, and can aid in minimizing thermal stress due to growth fusion bonding of dissimilar materials. While this initial substrate thinning process is acceptable for many applications, it can for some applications be impractical to handle a substantially thinned substrate in bringing the two substrates together, due to the fragility of the thinned substrate.

It therefore can be more preferable to first bring two thicker substrates together and evaporate a capillary fluid from between the substrates, thereby enforcing atomic contact between the substrates. Then at this point, thinning of one of the substrates can be carried out, with the second or additional substrates operating as a handle substrate for providing mechanical support. Once the substrate stack is pulled into atomic-scale contact, etchants for thinning a substrate cannot penetrate between the substrates. Thus, wet chemical etching, jet etching, or other selected etching technique can be employed. If desired, a layer of edge protection can be provided at the periphery of the substrate stack to ensure that etchants do not penetrate between the substrate surfaces. Chemo-mechanical polishing can also be employed where the strength of contact between the substrates is sufficiently high.

Whatever additional processing steps are carried out, at their completion, after an atomic-scale gap has been produced by the evaporation process of the invention, growth fusion of the two substrates is carried out by causing migration, i.e., mass transport, of atoms of the substrate materials to points of contact between the substrates. It is understood that this atomic migration substantially fills the gap between the substrates, with the thin gap space “condensed” to form spherical voids. FIGS. 2A-2C illustrates this condensation process.

FIG. 2A illustrates a substrate couple 12, 14 at the start of the growth fusion bonding process; points of contact 11 between the substrates are indicated. The growth fusion bonding process requires a temperature sufficient for atomic mobility. As thermal energy is added to the substrates, atoms become mobile and form covalent bonds, in a fashion similar to crystal growth, at points of substrate contact having sufficiently low surface energy.

As this covalent bond formation continues, as shown in FIG. 2B, the substrate interface 13 becomes monolithically integrated by the covalent bonds, with regions 15 of the interface yet to be bonded condensing. Then as shown in FIG. 2C such regions condense to very small spherical voids 17 that exist only right at the monolithically integrated interface. With this mechanism, the two substrates are growth fusion bonded into a monolithically integrated continuous crystalline material.

It is preferred that the exact temperature and duration employed for the growth fusion process step be determined empirically or semi-theoretically through measured vapor pressures of the substrate materials of interest, as vaporization is the atomic dissociation process that leads to mass transport and the ultimate growth fusion of the two substrates. Once the vaporization kinetics of given substrates have been measured, the temperature and time of the heat treatment are then preferably determined more accurately. It is recognized that the time and temperature factors can be traded off each other; a lower temperature can be employed with a longer duration of time. An inert, reducing, or other atmosphere can be employed during the growth fusion process, but as explained below, for many applications it can be preferred to provide an atmosphere that promotes the growth fusion.

Because the growth fusion process is understood to fundamentally involve crystal growth, high temperatures are theoretically desirable, but in practice a relatively low fusion temperature is in general preferred, for minimizing thermal stress and for minimizing bulk diffusion of dopants related to devices that may have been fabricated in one or both of the substrates prior to the fusion process. Thermal stress caused by differential expansion between two dissimilar substrate materials can result in defect generation, degrading device performance and reliability. In addition, thermal stress can cause the substrates to be pushed apart, thereby opening the atomic-scale gap produced by the evaporation process. For most applications, it is therefore preferable to employ a relatively lower fusion bonding temperature; for most applications, the fusion bonding temperature will be higher than the evaporation temperature, however, due to the requirement for atomic dissolution and mobility.

If a relatively higher temperature is desired, and/or there is a concern that the two substrates may become pushed apart during the fusion process, then in accordance with the invention the substrates can be held together with some pressing during the fusion. As explained above, however, it is preferred that no pressure be applied to the substrates, to avoid mechanical damage as well as pressure-induced stress on the substrates. It is understood in accordance with the invention that without application of pressure during the growth fusion process, the substrates are free to bow in correspondence with the degree of thermal expansion difference between the two substrates. This substrate bowing in accommodation of strain can reduce the thermal stress of the substrates. It is found that such bowing can substantially entirely relax as the substrates are cooled from the fusion temperature to room temperature.

### EXAMPLE 1

Substrate growth fusion bonding of substrate couples of the combinations of GaP, GaAs, InP, Si, and sapphire were carried out. Most of the substrate surfaces were left as bare, polished surfaces, but some of the substrates were provided with epitaxial layers. The substrate sizes ranged from full-size, 5 cm-diameter wafers to cleaved pieces of 0.5 cm-1.5 cm in extent. For each growth fusion bonding experiment, the substrates were thoroughly cleaned, including a light etch, were rinsed in methanol, and were assembled wet in the manner described above. Methanol was found to wet the surfaces of all materials included in the experiment.

The assembled substrates were then monitored for evaporation of the methanol under ambient room conditions. Specifically, as the methanol evaporated, interference fringes were monitored through the top surface of the transparent substrates, GaP and sapphire. The fringes gradually pushed out and eventually each entire substrate pair became fringeless except for a few spots. This fringeless condition indicated a wafer separation of less than one quarter of the visible wavelength, or approximately about 1000 Å. For the centimeter-sized substrates, this condition was usually reached in approximately 0.5 hours. Following the observation of a fringeless condition, several more hours of evaporation time were provided to achieve atomic contact between the surfaces to be bonded.

At the end of the evaporation period, the average air gap between several of the substrate pairs was measured by the evanescent-wave tunneling technique described above. The air gap was found consistently to be about 15 Å. The substrates were found to be so firmly held together at this point that they would not separate even after ultrasonic cleaning in a methanol bath for several hours.

In a next step, a growth fusion process was carried out on the substrates. In one of the experiments, an n-type GaAs/GaP substrate pair was placed in a furnace for a 30 minute heat treatment in a hydrogen ambient at a temperature that was ramped from ambient temperature to about 1010° C.

After the heat treatment, ohmic contact dots were subsequently fabricated on the outer faces of the bonded substrates. At applied voltage biases of greater than 10 V, electrical conduction showed a series resistance that was so low as to be dominated by the resistance of the GaP contacts. At low voltage bias, some nonlinearity was observed, indicative of a heterobarrier at the fusion interface.

GaAs/GaAs and GaP/GaP substrate pairs, heat treated at temperatures of 660° C. and 750° C., respectively, demonstrated ohmic conduction across the fused substrate interface, with series resistances that were so low as to be dominated by contact resistance. Stacks of Si substrates bonded to InP substrates on which were grown an epitaxial layer of In₅₃Ga₄₇As, heat treated at a temperature of 500° C., also exhibited good performance. Specifically, broad-area diodes of p-type Si and n-type InGaAs demonstrated a forward turn-on voltage of 0.6 V and a differential resistance of 6 Ω, comparable to that of a p-type Si substrate of 1 mm² area and 0.1 mm thickness. This substrate stack also exhibited strong electroluminescense peaking at a wavelength of about 1.65 μm. Mesa diodes exhibited reverse-bias currents lower than 0.1 μA/cm² at biases at or below about 1 V, but exhibited increased reverse-bias currents, up to several mA/cm² at 100 V, near junction breakdown. These results demonstrate the high quality monolithic integration that is produced by the growth fusion bonding process of the invention.

In accordance with the invention it is recognized that the growth fusion heat treatment procedure can be enhanced by supplying crystal growth promotion vapors, e.g., vapors of growth nutrients or surface activation stimulants, during this heat treatment. Specifically, during the heat treatment step there can be provided a selected one or more vapor constituents, at the location of a substrate stack being bonded, that promote the crystal growth by aiding in activation of the substrate surfaces and/or enhancing covalent bond formation of substrate material at the substrate interface. This vapor-enhanced heat treatment procedure can be carried out as part of a fusion bonding process that includes the evaporative capillarity surface attraction procedure of the invention described above and can additionally be carried out in fusion bonding processes not including the evaporative procedure.

For fusion bonding processes that include the evaporative surface attraction procedure, the vapor-enhanced heat treatment procedure of the invention is particularly attractive for promoting growth fusion at locations of bonding surfaces that are not entirely smooth or that exhibit surface defects. Such lack of smoothness and surface defects can to some extent limit the degree of atomic-scale proximity that can be attained by the evaporative procedure of the invention. Growth nutrients and/or surface activation constituents provided during the heat treatment procedure can aid in formation of covalent bonds even at the locations of these defects and non-smooth areas.

In addition, growth fusion promoters such as growth nutrients and/or surface activation constituents can aid in efficiency of the growth fusion process even for smooth substrate surfaces that are in atomic contact due to the evaporative process of the invention. This ability can be understood considering the specifics of the growth fusion mechanism. During a heat treatment step, growth fusion in general proceeds by mass transport of substrate material within the narrow gap between substrate surfaces to be bonded, where atomic dissociation, diffusion, and crystal growth lead to a “condensation” of the gap into round voids in order to minimize surface energy. When two substrates to be bonded are brought into atomic-scale contact, as with the evaporative capillarity surface attractive process of the invention, the gap between the substrates is very narrow. As a result, the mass transport of substrate material to central regions of the substrate surface planes can quickly slow down as the forming voids grow larger in diameter, i.e., as the surface-energy driving force becomes smaller. The provision of growth or surface activation vapor can aid in continuation of the mass transport process through the narrow surface gap to central surface locations even as such voids continue to grow and lower the fusion driving force.

It is further recognized in accordance with the invention that because of the significant enhancement in growth fusion that is enabled by vapor-enhanced heat treatment, for many applications a step of evaporative capillarity attraction is not essential. In other words, under appropriate conditions, the vapor-enhanced heat treatment process can enable effective surface activation and mass-transport covalent bond formation between surfaces separated by relatively large gaps. A growth nutrient supplied during the heat treatment can overcome the limitation of the surface-energy-induced mass transport for such configurations, enabling crystal growth that ultimately fills in even relatively large substrate stack gaps, even those approaching the micron regime.

Thus, the vapor-enhanced heat treatment procedure of the invention relaxes the conventional stringent bonding requirement for substrate flatness or smoothness, and further eliminates the need for applied pressure during the growth fusion. As a result, the varying degrees of non-flatness, roughness and/or hillock defects that often characterize substrates and layers grown on substrates can be accommodated while producing superior growth fusion results.

Considering specific growth vapor constituents, the growth vapor is preferably selected to provide the elemental composition of the substrate surfaces being bonded, thereby to provide precursors that cooperate with the substrate surface material itself for growing crystal material in the gap between the substrate surfaces. For example, given bonding between two GaP substrates, sources of gallium and phosphorus can be preferred for GaP crystal growth between the substrate surfaces. Given bonding between GaSb and GaAs, a source of gallium and antimony vapors can be employed as a growth vapor. With these examples, one skilled in the art can recognize the selection of suitable growth vapor constituents for selected substrate surfaces to be bonded.

Further in accordance with the invention, the heat treatment growth vapor can be selected to produce a grading of grown crystal composition between the two surfaces to be bonded. More specifically, the growth nutrient vapor can be selected to grow the crystal in the substrate gap with an intermediate composition from that of a first substrate surface to that of the opposing substrate surface. This enables tailoring of the bond interface, e.g., for reducing defect density or producing selected performance objectives.

In one example, the composition of the interface can be tailored to correspondingly tailor the energy band structure at the interface. For many applications, the difference in electron affinity between two materials to be bonded produces a spike in the energy bands at the location of the material bond interface, resulting in added electrical resistance across the bond interface. A graded composition across the interface produces a correspondingly graded energy structure that enables smoothing of this energy spike, and reduction of series resistance. Thus, in accordance with the invention, it can be preferred to select a growth nutrient vapor the composition of which is adjusted during a heat treatment step to produce an intermediate crystal composition and a corresponding reduction in series resistance. In one example of such, an intermediate composition of GaAs can be grown between a Si substrate bonded to an In₅₃Ga₄₇As layer.

As explained above, the supplied vapor can be a surface activation constituent instead of or in addition to being a growth nutrient. For example, it is known that arsenic or phosphorus are not complete growth nutrients by themselves for most III-V semiconductor compounds, but can be supplied to activate surfaces for enhancing substrate material mass transport and crystal growth at the substrate interface. This enhancement in turn can enable effective growth fusion at a reduced heat treatment temperature and/or a reduced heat treatment duration.

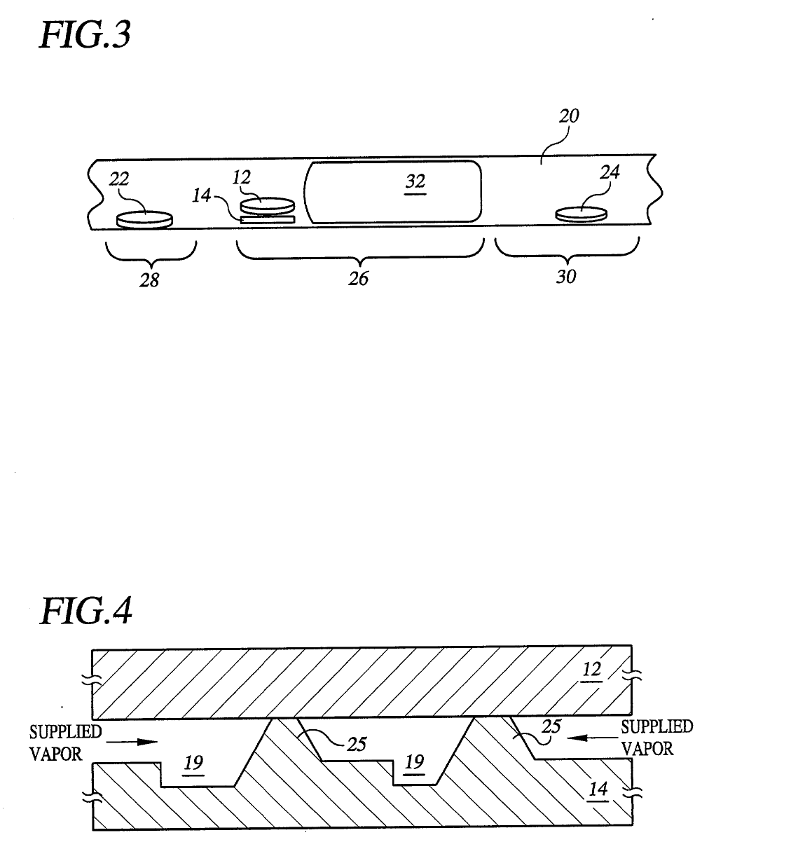

In carrying out the vapor-enhanced heat treatment growth fusion procedure of the invention a source, or sources, of a selected vapor, or vapors, is made available to the chamber, e.g., process tube of a furnace, in which the heat treatment process is to be carried out. Referring to FIG. 3, there is schematically shown such a process tube 20, including a substrate couple 12, 14 to be growth fusion bonded in accordance with the invention. For many applications it can be convenient to provide directly in the process tube a solid source of a selected vapor constituent. For example, sacrificial wafers 22 having a composition identical to that of one or both of the substrates or layers to be bonded can be employed as a vapor source when maintained at a sufficiently high temperature. For compound semiconductors, elemental sources 24, especially those of the more volatile components, e.g., the phosphorus component in GaP, can be preferable.

Elemental sources are preferably selected to provide adequate vapor pressure for a given application. For example, metallic Ga, red-phosphorous, arsenic, or other source can be employed. In addition, gas sources, such as phosphine gas or other selected gas constituent can be employed. Whatever source is employed, it preferably is selected to provide sufficient vapor concentration to the substrate bond interface being processed.

For many applications, it can be preferred as shown in FIG. 3 to employ both elemental sources as well as sacrificial substrates to provide all of the selected growth nutrient vapors. It therefore can be preferred to employ a relatively long process tube that accommodates distinct temperature zones, e.g., three zones 26, 28, 30, as shown in FIG. 3. Such temperature zones enable maintenance of the substrates 12, 14 to be bonded at a first temperature in a first zone 26, maintenance of sacrificial substrates 28 at a second temperature in a second zone 28, maintenance of elemental vapor sources 24 at a third temperature in a third zone 30, and so on for additional temperature zones, when needed. There preferably is provided sufficient diffusion retardation between the substrate assembly to be bonded and lower temperature zones to prohibit undesired vapor condensation.

It can further be preferred in accordance with the invention to include a plug, e.g., an evacuated, sealed quartz tube 32 as shown in FIG. 3, between a process tube zone holding the substrates to be bonded and an adjacent tube zone holding a growth nutrient source. The plug insert is preferably of a radial dimension somewhat less than that of the process tube. This configuration enables diffusion of the high concentration of Group V vapor around the plug while reducing a tendency for condensation that may be caused by large temperature gradients between tube zones.

The surface energy phenomenon that accompanies growth fusion requires that the vapor supply be not too high above equilibrium, such that crystal growth will proceed only at the designated bond interface. If the vapor saturation is too high, growth can occur anywhere, and will likely preferentially grow at the out regions of the substrate surfaces, where the vapor first encounters the substrates. This initial peripheral growth can block the narrow gap between the substrates, and possible cut off further growth at the inner substrate surface regions. However, if the vapor super-saturation is too small, the growth will be too slow as a practical matter. The use of a process tube plug insert can aid in achieving a desired vapor pressure. This configuration also can be employed to slow vapor out-diffusion and build up vapor pressure in the vicinity of substrates to be bonded.

When a sacrificial substrate of the same material as a substrate to be bonded is employed as a source for supplying a Group III vapor constituent, the temperature gradient, between the sacrificial substrate and the bonding substrate, required for adequate vapor transport is theoretically only a few degrees Celsius. But in practice, the required temperature gradient can be substantially higher, depending on the degree of vapor diffusion through a plug insert and depending on the degree of condensation, i.e., crystallization that may occur in cooler regions of the furnace process tube. For these reasons, rather large temperature gradients may be required between the substrate assembly to be bonded and the sacrificial substrates included for providing a vapor supply. The optimum temperature for each zone of the process tube is preferably determined experimentally for a given material system and process tube configuration.

It is recognized that in general, for a given III-V semiconductor compound, the vapor pressure of the Group V component is usually orders of magnitude higher than that of the Group III component. Sufficient supply of Group V vapor pressure is therefore required to prevent material decomposition, i.e., evaporation of the Group V component and formation of metallic droplets of the Group III species in a III-V semiconductor compound material. It is found in accordance with the invention that a vapor pressure of a selected Group V vapor is preferably considerably even higher than that required simply to prevent Group III decomposition. This supply of higher vapor pressure is required to prevent defect generation, particularly at highly non-planar surface regions or locations of surface defects.

It is also found in accordance with the invention that, contrary to the conventional wisdom, a relatively higher Group V vapor pressure also aids in increasing the mass transport rate associated with the growth fusion process. This experimental observation suggests that Group V vapor promotes surface dissociation, needed for mass transport, possibly by competing for chemical bonding to the Group III species on surfaces to be bonded, in a manner analogous to the dissolution of a solid to a solvent. In contrast, conventional understanding of spontaneous surface dissociation by thermal excitation suggests that such dissociation is suppressed by Group V vapor through reverse reaction and chemical equilibrium. Experimental observations suggest that this conventional process is more dominant in a regime of lower Group V vapor pressure.

The progress of the growth fusion procedure can be monitored in accordance with the invention with a variety of techniques. For substrate stacks in which at least one substrate is transparent to optical wavelengths, e.g., GaP, the growth fusion can be conveniently monitored with an ordinary microscope operated in the transmission mode. When the thickness of the gap between substrates is larger than a quarter of the wavelength, significant reflection occurs for the transmitting microscope light. As the gap is filled by progress of the growth fusion, this reflection is completely eliminated, and the grown-in region appears bright, in clear contrast to the unfilled gap region. This provides a very simple, efficient and nondestructive way to monitor the growth fusion process over an entire substrate surface.

Many semiconductors are transparent only to the infrared, but the growth fusion process can still be similarly monitored by using an infrared microscope. In this examination, as in the visible case, the top surface of the substrate stack is preferably relatively smooth for enabling the interface region to be seen clearly. This requirement is easily fulfilled by employing at least one substrate that is double-sided polished.

In accordance with the invention, there can be provided, in one or both substrate surfaces to be growth fusion bonded, one or more channels for further enhancing the vapor-enhanced heat treatment procedure of the invention. Referring to FIG. 4, by “channels” is here meant one or more depressions, recesses, or trenches 19 in one 14 or both of the substrate surfaces to be bonded. Such channels 19 operate during the vapor-enhanced heat treatment procedure as diffusion channels of supplied vapor to interior substrate surface areas. This enhancement of vapor diffusion aids in increasing the uniformity of vapor distribution across the surfaces to be bonded and aids in overcoming vapor diffusion obstacles, such as defects, that can be present on a substrate surface. The surface channels 19 thereby enhance the growth fusion process by enabling efficient formation of crystal growth fronts 25 at interior substrate surface locations.

The dimensions and configurations of surface channels across a substrate surface can be individually optimized for a given application. In general, channels of between about 1 μm and about 100 μm in width can easily be patterned and etched by conventional fabrication procedures and thus for many applications can be preferred. The spacing between channels is preferably sufficiently large so as not to impinge on surface area required for devices to be fabricated in the substrate, e.g., the active area of a light-emitting diode, but preferably is sufficiently small to ensure uniform vapor distribution. In a general example, the channel spacing can range from between about 50 μm to about 500 μm. Channels arranged in regularly spaced stripe patterns are the simplest to design, and are understood to provide sufficient diffusion area. More sophisticated channel patterns, such as mesh or star patterns, can nonetheless be employed for process optimization.

It is understood in accordance with the invention that substrate surface channels can further enhance the growth fusion process by providing nucleation sites at which crystal growth can occur. This nucleation enhancement is provided for the vapor-enhanced heat treatment procedure as well as for processes in which a growth vapor is not employed during the heat treatment procedure. Edges, corner recesses, and other asperities of the channel geometry can serve as nucleation sites to initiate crystal growth in the gap between substrate surfaces to be bonded.

If substrate surface channels are to be specifically employed for nucleation enhancement, then it can be preferred to correspondingly optimize the channel geometry for enhancing control of crystal nucleation. For example, corrugated, rather than straight, channel sides can be patterned to produce an array of nucleation sites. Deep channel sidewalls can be also be preferred for maximizing nucleation initiation. Vertical channel side walls are generally more desirable and can be more readily produced by, e.g., ion-beam etching. Relatively deeper channels may be more desired both for crystal nucleation and for vapor diffusion. Channels of between about 0.2 μm and about 20 μm in depth can for many materials be produced by conventional wet chemical or ion-beam-assisted etching techniques. For more optimized nucleation/growth and vapor supply, the surface channels can be asymmetrical, with nucleation strongly favored only on one side. This configuration enables a local crystal growth region to have ample vapor supply from a non-nucleation side of an adjacent surface channel. The overall channel system and pattern can thus be specifically designed to favor early nucleation and growth in the central interior substrate surface regions, so that growth propagates continuously from inner surface regions outward, thereby preventing growth premature cutoff by growth that was initiated at outer substrate surface regions.

### EXAMPLE 2

A 1 cm×1.5 cm n-type GaP substrate was growth fusion bonded to a p-type GaP substrate of the same size in accordance with the processes described above. In one of the substrates were produced 11-μm-deep channels of 25-μm width spaced at 250-μm intervals. Photoresist was employed as a channel etch mask and ion beam assisted etching was employed to produce the channels. At the completion of the channel etch, the photoresist was removed in the conventional manner and the substrate was subjected to an oxygen plasma cleaning step.

The two substrates were then cleaned, rinsed, and blown dried; no initial evaporative capillarity procedure was carried out on the two substrates. The substrates were aligned and then brought together. The gap between the substrates was measured to be as large as about 1 μm as evident from visible interference fringes.

The aligned substrate stack was positioned in a furnace process tube with a 2-g quartz block placed on the stack to hold the substrates in place. This block represented a negligible pressure application and was employed only to keep the wafers in place. A sacrificial GaP substrate was provided as a gallium source in the process tube, and phosphorus vapor near 1 atmospheric pressure was supplied by a red-phosphorus source provided in the tube. The tube zone holding the substrates to be bonded was ramped to a temperature of about 970° C., the sacrificial GaP substrate was maintained at a temperature of about 1190° C., and the red-phosphorous source was maintained at a temperature of between about 450° C.-530° C.

After a 31 hour vapor-enhanced heat treatment step, the gap between the two substrates was found to be nearly completely filled with crystal, as determined by visual inspection under an optical microscope operated in a transmission mode. The efficiency of growth nucleation along the surface channels was verified. A pn junction was formed across the bonded substrates and the diodes fabricated showed good forward turn-on and very low reverse saturation current, indicative of a good junction.

Considering other attributes of the surface channels to be provided in accordance with the invention, in addition to operating as nucleation sites, surface channels can also serve as buffer zones that reduce thermal stresses of a substrate stack when the stack is cooled to ambient temperature from the temperature of the growth fusion heat treatment procedure. For this application, it can be preferred to optimize the channel geometry such that heat is evenly dissipated from across the substrate stack surface. In general, the various channel geometries described above are all suitable for thermal stress dissipation of a substrate stack.

Further in accordance with the invention, substrate surface channels can be employed to aid in the evaporative capillarity surface attraction procedure of the invention as described above. In this capacity, the surface channels operate as “pulling points” for the evaporative liquid capillarity process. As a result, the surface channels can provide the ability to pull substrate surfaces into contact more completely, minimizing local regions that are not in atomic-scale contact. The channels also can aid in out-diffusion and evaporation of the capillary attractive liquid from central surface regions of substrates, thereby significantly shortening the time required for full evaporation of the attractive fluid.

### EXAMPLE 3

A GaInAsSb/GaSb heterostructure substrate was growth fusion bonded to a GaAs substrate. The GaInAsSb/GaSb heterostructure was produced by organometallic vapor-phase epitaxy (OMVPE) on the GaSb substrate. Inspection of the resulting substrate identified defects of about 20 μm in height observed at a low density of approximately one per square centimeter. These defects were individually scraped away with a knife.

The GaAs substrate was thinned to a thickness of about 190 μm. To produce this thinning, the front side of the GaAs substrate was coated with silicon oxide by pyrolytic deposition. The backside of the GaAs substrate was then chemo-mechanically polished to the desired thickness. In one experiment, the GaAs substrate was provided with surface channels having a depth of about 2 μm, a width of about 25 μm, and an interval spacing of about 250 μm. The channels were produced by wet chemical etching with photoresist remover, employing a patterned silicon dioxide layer as an etch mask. In a second experiment, the GaAs substrate was not provided with surface channels. In either case, the two substrates were cleaved to the dimensions given above, and then thoroughly ultrasonically cleaned in acetone.

After both substrates were cleaned, the substrates were immersed in methanol and then assembled wet on a quartz pedestal. After the methanol was observed to have evaporated from the backside of the substrates, the substrates were then loaded into a heat treatment process tube, along with a GaSb sacrificial substrate for producing Ga vapor, at room temperature and the tube was purged overnight with ultra high purity Ar. At the end of the purging, the system was baked at a lower temperature to outgas the adsorbed moisture and other potential contaminants. During the subsequent heat treatment process, the GaSb sacrificial substrate provided in the process tube was maintained at a temperature of 750° C. The heat treatment process was carried out at a substrate bonding temperature of 350° C. for about 75 hours.

At the conclusion of the growth fusion bonding process, the thick GaSb substrate was removed from the bonded assembly, leaving the GaInAsSb layer on the GaAs substrate for device testing. To remove the GaSb substrate, first the bulk of the substrate thickness was removed by mechanical lapping, followed by chemomechanical polish to smooth out the surface. Then an etchant was employed to selectively remove the remaining GaSb and the GaSb buffer layer. GaSb was selectively etched using CrO₃:HF:H₂O until the InAsSb layer was exposed. Finally, the InAsSb etch-stop layer was removed with H₂O₂ saturated with citric acid.

The resulting wafer-fused epitaxy was then ready for device testing. To evaluate the optical quality of the GaInAsSb epitaxy, photoluminescence measurements were made at room temperature. The sample was excited with a laser at an energy greater than the bandgap of the GaInAsSb, with the emission of photons generated by recombination of electrons and holes then detected. Strong GaInAsSb photoluminescence was measured for both substrate couples in which GaAs surface channels were provided and substrate couples in which GaAs surface channels were not provided, in sharp contrast to a much weakened luminescence from control samples fused with large pressure application. It was also found that the photoluminescence was several times larger for the substrate couple including GaAs surface channels. It is understood that this result was due to thermal stress relief provided by the surface channels.

Based on these experimental results and the description provided above, it is clear that the growth fusion bonding processes of the invention provide elegantly simple and repeatable, reliable techniques for producing high quality, monolithically integrated substrates and layers. It is recognized, of course, that those skilled in the art may make various modifications and additions to the processes of the invention without departing from the spirit and scope of the present contribution to the art. Accordingly, it is to be understood that the protection sought to be afforded hereby should be deemed to extend to the subject matter of the claims and all equivalents thereof fairly within the scope of the invention.

We claim:

1. A method for bonding a first crystalline semiconductor substrate to a second crystalline semiconductor substrate, comprising:
applying to a first surface of the first substrate and to a first surface of the second substrate a liquid that wets both substrate first surfaces;
bringing the first surface of the first substrate together with the first surface of the second substrate while the liquid substantially remains on both first surfaces;
evaporating the liquid from the substrate first surfaces, while the substrate first faces are together, at an evaporation temperature that is below the boiling point of the liquid at ambient pressure; and
heat treating the substrates at a temperature above the evaporation temperature.

2. The substrate bonding method of claim 1 wherein the heat treatment temperature is selected to cause mass transport of substrate material for crystal growth at the substrate first surfaces, to produce covalent bonds between the substrate first surfaces.

3. The substrate bonding method of claim 1 wherein the evaporation temperature is room temperature.

4. The substrate bonding method of claim 1 wherein the liquid comprises methanol.

5. The substrate bonding method of claim 1 wherein the liquid evaporation and substrate heat treatment are carried out without application of pressure to the substrates.

6. The substrate bonding method of claim 1 further comprising thinning at least one of the substrates before applying the liquid to the substrate first surfaces.

7. The substrate bonding method of claim 1 further comprising thinning at least one of the substrates after evaporating the liquid from the substrate first surfaces.

8. The substrate bonding method of claim 1 wherein the first substrate comprises a semiconductor material composition that is heterogeneous with semiconductor material composition of the second substrate.

9. The substrate bonding method of claim 1 wherein at least one of the substrate first surfaces includes at least one epitaxial layer that is heterogeneous with substrate material composition.

10. The substrate bonding method of claim 1 further comprising forming surface channels in at least one of the substrate first surfaces before applying the liquid to the substrate first surfaces.

11. The substrate bonding method of claim 10 wherein the surface channels are provided in a pattern selected to provide sites of crystal nucleation during the substrate heat treatment.

12. The substrate bonding method of claim 10 wherein the surface channels are of a corrugated geometry.

13. The substrate bonding method of claim 1 wherein a selected crystal growth promotion vapor is supplied to the substrates during heat treatment of the substrates.

14. The substrate bonding method of claim 13 wherein the crystal growth promotion vapor comprises a selected semiconductor surface activation vapor supplied to the substrates during heat treatment of the substrates.

15. The substrate bonding method of claim 13 wherein the crystal growth promotion vapor comprises a selected crystal growth nutrient vapor corresponding to semiconductor material composition of at least one of the substrates.

16. The substrate bonding method of claim 13 wherein the crystal growth promotion vapor is supplied by a semiconductor material corresponding to semiconductor composition of at least one of the first and second substrates.

17. The substrate bonding method of claim 13 wherein the crystal growth promotion vapor comprises a selected crystal growth nutrient vapor corresponding to a semiconductor material composition that is intermediate with semiconductor material composition of the substrates.

18. The substrate bonding method of claim 13 wherein the crystal growth promotion vapor is supplied as a gas delivered to the first and second substrates.

19. A method for bonding a first crystalline semiconductor substrate to a second crystalline semiconductor substrate, comprising:
forming surface channels in a first surface of at least one of the first and second substrates;
bringing the first surface of the first substrate together with the first surface of the second substrate; and
heat treating the substrates while supplying a crystal growth promotion vapor to the substrates.

20. The substrate bonding method of claim 19 wherein the surface channels are provided in a pattern selected to provide sites of crystal nucleation during the substrate heat treatment.

21. The substrate bonding method of claim 19 wherein the heat treatment temperature is selected to cause mass transport of substrate material for crystal growth at the substrate first surfaces, to produce covalent bonds between the substrate first surfaces.

22. The substrate bonding method of claim 19 wherein the crystal growth promotion vapor comprises a selected crystal growth nutrient vapor corresponding to semiconductor material composition of at least one of the substrates.

23. The substrate bonding method of claim 19 wherein the crystal growth promotion vapor comprises a selected crystal growth nutrient vapor corresponding to a semiconductor material composition that is intermediate with semiconductor material composition of the substrates.

24. The substrate bonding method of claim 19 wherein the crystal growth promotion vapor comprises a selected semiconductor surface activation vapor.

25. The substrate bonding method of claim 19 wherein the crystal growth promotion vapor is supplied by a semiconductor material corresponding to semiconductor composition of at least one of the first and second substrates.

26. The substrate bonding method of claim 19 wherein the crystal growth promotion vapor is supplied as a gas delivered to the first and second substrates.

27. The substrate bonding method of claim 19 wherein surface channels are formed in the first surface of each of the first and second substrates.

28. The substrate bonding method of claim 19 wherein the surface channels are characterized by substantially vertical sidewalls.

29. The substrate bonding method of claim 19 wherein the surface channels are of a corrugated geometry.

30. The substrate bonding method of claim 19 wherein the first surface of first and second substrates are both substantially dry when the first surface of the first substrate is brought together with the first surface of the second substrate.

31. The substrate bonding method of claim 19 wherein at least one of the substrate first surfaces includes at least one epitaxial layer that is heterogeneous with substrate material composition.

32. The substrate bonding method of claim 19 further comprising:
applying to the first surface of the first substrate and to the first surface of the second substrate a liquid that wets both substrate first surfaces, before bringing the substrate first surfaces together; and
after bringing the substrate first surfaces together, evaporating the liquid from the substrate first surfaces at an evaporation temperature that is below the boiling point of the liquid at ambient pressure;
and wherein the first surface of the first substrate is brought together with the first surface of the second substrate while the liquid substantially remains on both first surfaces, and the substrates are heat treated at a temperature that is above the evaporation temperature.

33. The substrate bonding method of claim 32 further comprising thinning at least one of the substrates before applying the liquid to the substrate first surfaces.

34. The substrate bonding method of claim 32 further comprising thinning at least one of the substrates after evaporating the liquid from the substrate first surfaces.

35. The substrate bonding method of claim 32 wherein the evaporation temperature is room temperature.

36. The substrate bonding method of claim 32 wherein the liquid comprises methanol.

37. The substrate bonding method of claim 32 wherein the liquid evaporation and substrate heat treatment are carried out without application of pressure to the substrates.
